(19) United States
(12) Patent Application Publication
(10) Pub. No.: US 2026/0151775 A1
(43) Pub. Date: Jun. 4, 2026

(54) COMMINUTION ASSEMBLY

(71) Applicant: PRESTIGE TRADING CO., PTY LTD., Glenorie, NSW (AU)

(72) Inventor: Craig Steven Wills, Glenorie NSW (AU)

(73) Assignee: PRESTIGE TRADING CO. PTY LTD, Glenorie, NSW (AU)

(21) Appl. No.: 19/122,300

(22) PCT Filed: Oct. 21, 2023
(86) PCT No.: PCT/AU2023/051056

§ 371 Date: Apr. 18, 2025

(30) Foreign Application Priority Data
Oct. 21, 2022 (AU) 2022903115

(51) Int. Cl. B02C 13/20; B02C 4/02; B02C 13/06; B02C 13/28

(52) U.S. Cl. CPC B02C 13/20; B02C 4/02; B02C 13/06; B02C 13/2804; B02C 2013/2808; B02C 2210/02

(57) ABSTRACT

There is disclosed a comminution assembly (110) including a first comminution shaft (112) and a second comminution shaft (113) laterally spaced apart from the first comminution shaft (112). In use the first and second comminution shaft (112, 113) cooperate to comminute material passing between them. The first comminution shaft (112) includes a comminution element mounting assembly (114) which includes (i) an element seat (116) operatively associated with the first comminution shaft (112), and (ii) a comminution element (118) operatively adapted to impact material passing between the first and second comminution shaft (112, 113). The comminution element (118) is detachably mounted to the element seat (116).

### FIELD

The invention relates to a comminution assembly. In one non-exclusive aspect the invention concerns a comminution assembly to comminute building waste such as concrete.

### BACKGROUND

One type of comminution machine employed to comminute building waste includes two laterally spaced apart comminution shafts. Each shaft includes a plurality of outwardly extending comminution elements adapted to impact chunks of material. Material is broken into smaller parts when the shafts rotate and material passing between the shafts are impacted by the comminution elements.

A drawback of the above comminution shafts is that they are costly. If only one or two comminution elements are worn away or damaged, it is required that the entire comminution shaft be replaced. Such replacement will render the comminution machine inoperable with resulting costs and inconvenience flowing from machine downtime.

### OBJECT

It is an object of the present invention to provide a comminution assembly which addresses the above problems or at least provides a useful alternative comminution assembly.

### SUMMARY

According to a first aspect there is disclosed herein a comminution assembly including:
a first comminution shaft; and
a second comminution shaft laterally spaced apart from the first comminution shaft,
the first and second comminution shaft in use cooperating to comminute material passing between them;
wherein the first comminution shaft includes a comminution element mounting assembly, the comminution element mounting assembly including (i) an element seat operatively associated with the first comminution shaft, and (ii) a comminution element operatively adapted to impact material passing between the first and second comminution shaft, the comminution element detachably mounted to the element seat.

Preferably (i) the element seat defines an element seat outer surface, and (ii) the comminution element defines a comminution element inner surface wherein the comminution element inner seat surface abuts the element seat outer surface when the comminution element is mounted to the element seat.

Preferably the element seat is attached to a shaft collar, the shaft collar adapted to be coupled to the first comminution shaft.

Preferably the shaft collar defines a bore operatively adapted to receive the first comminution shaft.

Preferably the shaft collar is secured in position on the first comminution shaft.

Preferably the comminution element includes an element base and a first and second element leg outwardly extending from the element base.

Preferably the shaft collar defines a first and a second collar slot, the first and second collar slot being located on opposite sides of the element seat.

Preferably a portion of the first element leg is located within the first collar slot and a portion of the second element leg is located in the second collar slot when the comminution element is mounted to the element seat.

Preferably the element seat is enclosed by the element base and the first and second element leg when the comminution element is mounted to the element seat.

Preferably the comminution element is secured to the element seat with one or more fasteners.

Preferably the element seat is a first element seat, and a second element seat is attached to the shaft collar opposite the first element seat.

Preferably the comminution element is a first comminution element, and a second comminution element is detachably mounted to the second element seat.

In a second aspect there is provided a comminution element mounting assembly operatively adapted for use in the comminution assembly of the first aspect.

In a third aspect there is provided a comminution element operatively adapted for use in the comminution assembly according to the first aspect.

In a fourth aspect there is provided a shaft collar operatively adapted for use in the comminution assembly of the first aspect.

In a fifth aspect there is disclosed a comminution element mounting assembly for use in a comminution assembly comprising a first comminution shaft and a laterally spaced apart second comminution shaft, the comminution element mounting assembly including (i) an element seat operatively associated with the first comminution shaft, and (ii) a comminution element operatively adapted to impact material passing between the first and second comminution shaft, the comminution element detachably mounted to the element seat.

Preferably the element seat includes a first and second element seat ear, the first and second element seat ear defining a seat recess between them, and wherein the comminution element includes an element protrusion outwardly extending from an element base of the comminution element, the element protrusion adapted to be located within the seat recess.

Preferably each of the first and second element seat ear includes a fastener opening and the comminution element in turn includes corresponding element openings adapted to be aligned with the fastener opening of the first and second seat element ear to facilitate fastening with elongate fasteners.

Preferably each first and second element seat ear includes a cross-opening which crosses a corresponding fastener opening.

### BRIEF DESCRIPTION OF THE DRAWINGS

Preferred embodiments of the invention will be described hereinafter, by way of examples only, with reference to the accompany drawings wherein:

FIG. 1 is an end view of a first comminution shaft of a first embodiment comminution assembly;

FIG. 2 is a perspective view of a comminution element mounting assembly of the comminution assembly of FIG. 1;

FIG. 3 is a front view of the comminution element mounting assembly of FIG. 2;

FIG. 4 is a perspective view of a second embodiment comminution assembly;

FIG. 5 is perspective view of an element body for use in the comminution assembly of

FIG. 6 is a perspective view of a comminution element adapted to be secured to the element body of FIG. 5.

### DESCRIPTION OF PREFERRED EMBODIMENTS

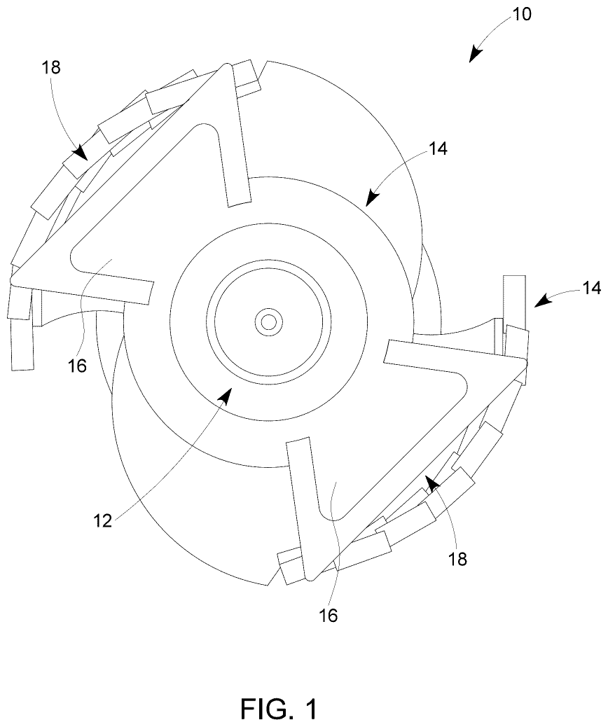

FIG. 1 shows a first embodiment comminution assembly, generally indicated with the reference numeral 10. The comminution assembly 10 is adapted for use in a comminution machine such as a shredder sold under the trade name Impaktor 250 EVO and produced by Arjes GmbH. In such use the comminution assembly 10 will replace the side combs assembly currently employed in the Impaktor 250 EVO.

FIG. 1 shows a first comminution shaft 12 of the comminution assembly 10. The comminution assembly 10 will in use include a non-illustrated second comminution shaft laterally spaced apart from the first comminution shaft 12. In use the first comminution shaft 12 will cooperate with the second comminution shaft in a conventional manner to comminute material passing between them. In one application the comminution assembly 10 is employed to crush building waste such as concrete. In another application the comminution assembly 10 can be employed as a shredder to comminute wooden products such as pallets.

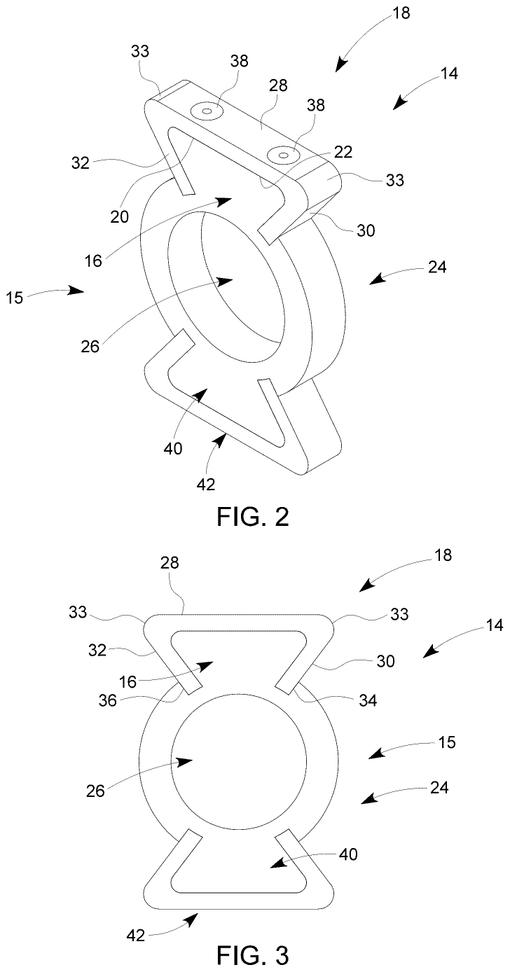

The first comminution shaft 12 includes a comminution element mounting assembly 14. The first comminution shaft 12 includes a plurality of further comminution element mounting assemblies 14, similar to the comminution element mounting assembly 14, which are longitudinally spaced apart along the length of the first comminution shaft 12. Referring also to FIGS. 2 and 3, the comminution element mounting assembly 14 includes (i) an element body 15 having an element seat 16 operatively associated with the first comminution shaft 12, and (ii) a comminution element 18 operatively adapted to impact material passing between the first comminution shaft 12 and the non-illustrated second comminution shaft. The comminution element 18 is detachably mounted to the element seat 16 for purposes discussed below.

The element seat 16 defines an element seat outer surface 20 and the comminution element 18 in turn defines a comminution element inner surface 22. The comminution element inner surface 22 abuts the element seat outer surface 20 when the comminution element 18 is mounted in position to the element seat 16.

The element body 15 includes a ring-shaped shaft collar 24 which is attached to the element seat 16. The shaft collar 24 is adapted to be coupled to the first comminution shaft 12. The shaft collar 24 defines a bore 26 operatively adapted to receive the first comminution shaft 12. In use the shaft collar 24 is secured in position on the first comminution shaft 12, typically by way of welding. Prior to being secured on the first comminution shaft 12, the comminution shaft 12 is introduced to the bore 26 of the shaft collar 24. Hereafter the shaft collar 24 is slid along to the comminution shaft 12 until it is located in a required location whereafter it is secured in position.

The comminution element 18 includes an element base 28 and a first and second element leg 30, 32 outwardly extending from the element base 28. The shaft collar 24 defines a first and a second collar slot 34, 36, shown in FIG. 3, which are located respectively on opposite sides of the element seat 16. A portion of the first element leg 30 is located within the first collar slot 34 and a portion of the second element leg 32 is located in the second collar slot 36 when the comminution element 18 is mounted to the element seat 16. The element seat 16 is enclosed by the element base 28 and the first and second element leg 30, 32 when the comminution element 18 is mounted to the element seat 16. Having portions of the first and second element legs 30, 32 respectively located within the first and second collar 34, 36 assist in maintaining the comminution element 18 in place during a comminution operation.

In this embodiment the first and second element legs 30, 32 provide wear surfaces 33 which in use will be worn away as a result of an extended period of comminution. It is further pointed outed that the shape of outer surfaces of the first and second leg 30, 32 could vary to make them more appropriate for different materials that are to undergo a comminution process.

The comminution element 18 is secured in position to the element seat 16 with two fasteners 38. In this embodiment the fasteners 38 are provided in the form of two countersunk bolts.

In this embodiment the element seat 16 is a first element seat, and the element body includes a second element seat 40 attached to the shaft collar 24 in a position diametrically opposed to the first element seat 16. Further, the comminution element 18 is a first comminution element, and a second comminution element 42 is detachably mounted to the second element seat 40.

After the comminution element 18 and the second comminution element 42 have undergone an amount of wear, the fasteners 38 can be removed to loosen the comminution element 18 and the second comminution element 42. The comminution element 18 and the second comminution element 42 can then be removed respectively from the element seat 16 and the second element seat 40. The comminution element 18 and the second comminution element 42 can then be rotated through 180° so that unworn surfaces of the comminution element 18 and the second comminution element 42 can be located in an operative position to impact material passing between the first comminution shaft 12 and the non-illustrated second comminution shaft. This feature also enables a user to replace only worn comminution elements with a new/replacement comminution element. A user can purchase individual spare part comminution elements so that those are to hand to replace individual worn comminution elements. This is different to current comminution assemblies where it will be required to replace an entire comminution shaft in the case of only a few comminution elements having been worn away.

In a non-illustrated embodiment the element seat 16 and the second element seat 40 do not include a shaft collar, but are welded directly onto an outer surface of the first comminution shaft 12.

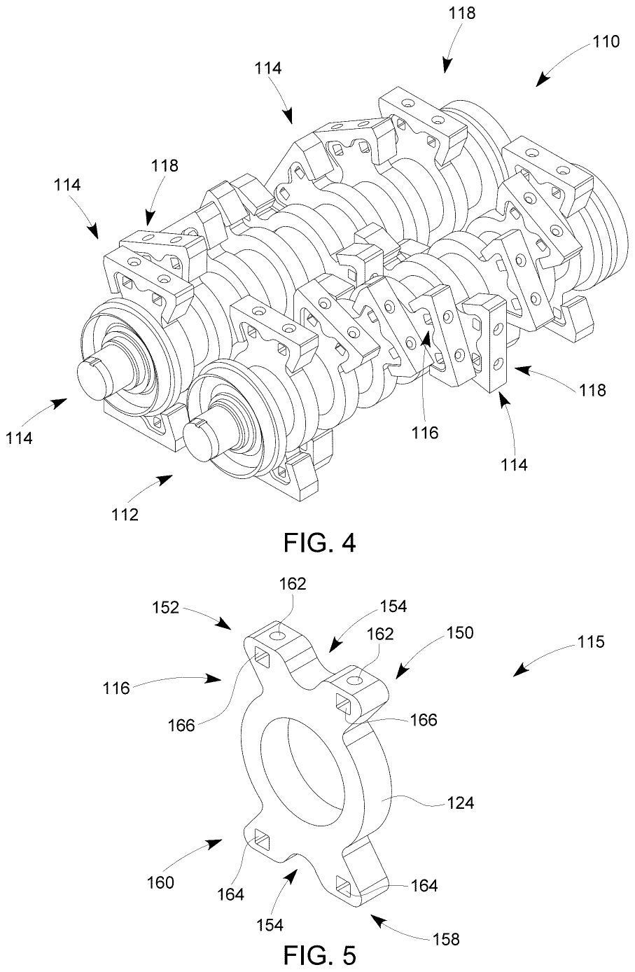

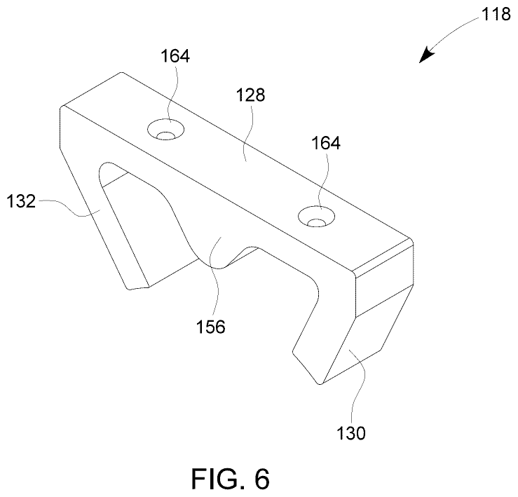

FIG. 4 shows a second embodiment comminution assembly 110 comprising a first comminution shaft 112 and a second comminution shaft 113 laterally spaced apart from the first comminution shaft 112. The first and second comminution shaft 112, 113 include a plurality of comminution element mounting assemblies 114, which are respectively longitudinally spaced apart along the length of the first and second comminution shaft 112, 113. Referring also to FIGS. 5 and 6, each comminution element mounting assembly 114 includes (i) an element body 115 having a first element seat 116 operatively associated respectively with the first or second comminution shaft 112, 113 and (ii) a comminution element 118 operatively adapted to impact material passing between the first and second comminution shaft 112, 113. The/each comminution element 118 is detachably mounted to an associated element seat 116.

The element seat 116 defines an element seat outer surface 120 and the comminution element 118 in turn defines a comminution element inner surface 122. The comminution element inner seat surface 122 abuts the element seat outer surface 120 when the comminution element 118 is mounted in position to the element seat 116.

The element body 115 includes a ring-shaped shaft collar 124 which is attached to the element seat 116. The shaft collar 124 is adapted to be coupled to the first or second comminution shaft 112, 113. The shaft collar 124 defines a bore 126 operatively adapted to receive the first or second comminution shaft 112, 113.

The comminution element 118 includes an element base 128 and a first and second element leg 130, 132 outwardly extending from the element base 128. The element seat 116 is enclosed by the element base 128 and the first and second element leg 130, 132 when the comminution element 118 is mounted to the element seat 116.

The element seat 116 includes a first and second element seat ear 150, 152 which define a seat recess 154 between them. The comminution element 118 in turn includes an element protrusion 156 outwardly extending from the element base 128. The element protrusion 156 is configured and adapted to be located within the seat recess 154 formed by the first and second element seat ear 150, 152 when the comminution element 118 is seated on the element seat 116.

The element seat 116 is a first element seat, and the element body 118 includes a second element seat 140 attached to the shaft collar 124 in a position diametrically opposite the first element seat 116. A second comminution element 118 is in use detachably mounted to the second element seat 140. The second element seat 140 includes a first and second element seat ear 158, 160 which operate in the same manner as the first element seat 116.

Each of the first and second element seat ears 150, 158, 152, 160 includes a fastener opening 162. The comminution element 118 in turn includes an element opening 164. By respectively aligning the fastener openings 162 of the first and second seat element ear 150, 158 152, 160 with the element openings 164, non-illustrated elongate fasteners, here in the form of bolts, can pass therethrough to secure the comminution element 118 to the first and second element seat ear 150, 152. Each of the first and second element seat ear 150, 158, 152, 160 includes a cross-opening 166 which crosses their respective fastener opening 162 so as to hold a nut to secure the bolts within the respective fastener openings 162 of the first and second seat elements 150, 158, 152, 160.

Although the invention has been described with reference to specific examples, it will be appreciated by those skilled in the art that the invention may be embodied in many other forms.

### KEY TO REFERENCE NUMERALS IN DRAWINGS

10 First embodiment comminution assembly
12 First comminution shaft
14 Comminution element mounting assembly
15 Element body
16 Element seat
18 Comminution element
20 Element seat outer surface
22 Element inner surface
24 Shaft collar
26 Bore
28 Element base
30 First element leg
32 Second element leg
33 Wear surface
34 First collar slot
36 Second collar slot
38 Fastener
40 Second element seat
42 Second comminution element
110 Second embodiment comminution assembly
112 First comminution shaft
113 Second comminution shaft
114 Comminution element mounting assembly
115 Element body
116 First element seat
118 Comminution element
120 Element seat outer surface
122 Comminution element inner surface
124 Shaft collar
126 Bore
128 Element base
130 First element leg
132 Second element leg
140 Second element seat
150 First element seat ear
152 Second element seat ear
154 Seat recess
156 Element protrusion
158 First element seat ear
160 Second element seat ear
162 Fastener opening
164 Element opening
166 Cross-opening

1. A comminution assembly including:
a first comminution shaft; and
a second comminution shaft laterally spaced apart from the first comminution shaft,
the first and second comminution shaft in use cooperating to comminute material passing between them;
wherein the first comminution shaft includes a comminution element mounting assembly, the comminution element mounting assembly including (i) an element seat operatively associated with the first comminution shaft, and (ii) a comminution element operatively adapted to impact material passing between the first and second comminution shaft, the comminution element detachably mounted to the element seat.

2. A comminution assembly according to claim 1, wherein (i) the element seat defines an element seat outer surface, and (ii) the comminution element defines a comminution element inner surface wherein the comminution element inner seat surface abuts the element seat outer surface when the comminution element is mounted to the element seat.

3. A comminution assembly according to claim 2, wherein the element seat is attached to a shaft collar, the shaft collar adapted to be coupled to the first comminution shaft.

4. A comminution assembly according to claim 3, wherein the shaft collar defines a bore operatively adapted to receive the first comminution shaft.

5. A comminution assembly according to claim 4, wherein the shaft collar is secured in position on the first comminution shaft.

6. A comminution assembly according to claim 5, wherein the comminution element includes an element base and a first and second element leg outwardly extending from the element base.

7. A comminution assembly according to claim 6, wherein the shaft collar defines a first and a second collar slot, the first and second collar slot being located on opposite sides of the element seat.

8. A comminution assembly according to claim 7, wherein a portion of the first element leg is located within the first collar slot and a portion of the second element leg is located in the second collar slot when the comminution element is mounted to the element seat.

9. A comminution assembly according to claim 6, wherein the element seat is enclosed by the element base and the first and second element leg when the comminution element is mounted to the element seat.

10. A comminution assembly according to claim 6, wherein the comminution element is secured to the element seat with one or more fasteners.

11. A comminution assembly according to claim 10, wherein the element seat is a first element seat, and a second element seat is attached to the shaft collar opposite the first element seat.

12. A comminution assembly according to claim 11, wherein the comminution element is a first comminution element, and a second comminution element is detachably mounted to the second element seat.

13. A comminution assembly according to claim 1, wherein the element seat includes a first and second element seat ear, the first and second element seat ear defining a seat recess between them, and wherein the comminution element includes an element protrusion outwardly extending from an element base of the comminution element, the element protrusion adapted to be located within the seat recess.

14. A comminution element mounting assembly for use in comminution assembly comprising a first comminution shaft and a laterally spaced apart second comminution shaft, the comminution element mounting assembly including (i) an element seat operatively associated with the first comminution shaft, and (ii) a comminution element operatively adapted to impact material passing between the first and second comminution shaft, the comminution element detachably mounted to the element seat.

15. A comminution element mounting assembly according to claim 14, wherein the element seat includes a first and second element seat ear, the first and second element seat ear defining a seat recess between them, and wherein the comminution element includes an element protrusion outwardly extending from an element base of the comminution element, the element protrusion of the comminution element adapted to be located within the seat recess of the element seat.

16. A comminution element mounting assembly according to claim 15, wherein each of the first and second seat element ear includes a fastener opening and the comminution element in turn includes corresponding element openings adapted to be aligned with the fastener opening of the first and second seat element ear to facilitate fastening with elongate fasteners.

17. A comminution element mounting assembly according to claim 16, wherein each first and second element seat ear includes a cross-opening which crosses a corresponding fastener opening.

18-19. (canceled)
